(19) United States
(12) Patent Application Publication
(10) Pub. No.: US 2008/0069489 A1
(43) Pub. Date: Mar. 20, 2008

(54) Bearing end cover

(75) Inventors: Michael D. Drake, Simpsonville, SC (US); Philip C. Tierno, Greenville, SC (US); Ryan N. DeWachter, Simpsonville, SC (US)

Correspondence Address: THOMPSON COBURN, LLP, ONE US BANK PLAZA, SUITE 3500, ST LOUIS, MO, 63101, US

(73) Assignee: Rockwell Automation Technologies, Inc.

(21) Appl. No.: 11/523,919

(22) Filed: Sep. 20, 2006

(51) Int. Cl. F16C 33/76

(52) U.S. Cl. 384/489

(57) ABSTRACT

A bearing cover includes a clip securable to a bearing housing and an end cover securable to the clip to cover a central opening of the bearing housing. The clip may be secured to a grease fitting or other structural component attached to the bearing housing. The relative location and engagement of the clip and end cover may be adjusted to accommodate different sizes and configurations of bearing housings.

### BACKGROUND

The present invention relates generally to bearings, such as antifriction bearings. More particularly, the invention relates to add-on covers for covering an opening in bearing housings or over shafts supported by bearings.

Bearings are ubiquitous throughout industry. Many different types and styles of bearings have been developed and are in use, such as ball bearings, roller bearings, so forth. Moreover, housing styles for such bearings include pillow block housings, flanged housings, and tapped base housings. The particular type of bearing and housing style are generally selected based upon such factors as the mechanical constraints of the application (i.e., the layout of equipment), and the anticipated loading.

Most industrial bearings include a housing in which a bearing set or insert is supported. The housing, regardless of the style, has a central opening that receives a rotating member to be supported by the bearing. The central aperture generally extends completely through the housing (and bearing set), such that the rotating member, typically a shaft, can enter from either side, and extend through the housing and bearing, where desired (i.e., exiting an opposite side thereof).

For many reasons, it may be important and desirable to provide an end cover to cover the aperture in bearing housings, as well as the end of shafts supported by the bearing housings. For example, an end cover may prevent exposure to a rotating shaft, thus, helping avoid interfering with its operation and maintaining the bearing relatively clean and free of debris. A wide variety of end covers are currently available. However, they may be difficult to install, dislodge through incidental contact, or have limited compatibility due to size or shape (i.e., they do not accommodate a range of different bearing housing sizes).

### BRIEF DESCRIPTION

In accordance with one aspect of the invention, a bearing cover is provided. The bearing cover includes a clip securable to a bearing housing. Additionally, the bearing cover includes an end cover configured to be secured to the clip and to cover a central opening of the bearing housing. The clip and cover may be designed to fit a range of bearing and housing styles. Moreover, the arrangement may permit the cover to be positioned on the clip in such a way as to accommodate different sizes of housing.

In accordance with another aspect, a method of covering a bearing assembly is provided. The method includes securing a clip to a bearing housing. An end cover is then secured to the clip to cover an opening or aperture in the housing. The cover may fit into a straight bore of the bearing housing. The cover may be slid or displaced on the clip, where desired, to properly position the cover over the housing aperture.

### DRAWINGS

These and other features, aspects, and advantages of the present invention will become better understood when the following detailed description is read with reference to the accompanying drawings in which like characters represent like parts throughout the drawings, wherein:

FIG. 1 is perspective view of a bearing assembly in a pillow block style housing with an end cover in accordance with an exemplary embodiment of the present invention;

FIG. 2 is perspective view of an exemplary end cover and attachment clip assembly in accordance with an exemplary embodiment of the present invention;

FIG. 3 is a perspective view of an alternative configuration of the end cover of FIG. 2 in accordance with an exemplary embodiment of the present invention;

FIG. 4 is a perspective view of an exemplary attachment clip configured to fit around a hexagonal head of a fastener or grease fitting in accordance with an exemplary embodiment of the present invention;

FIG. 5 is a perspective view of another exemplary attachment clip which can be pressed over a grease fitting in accordance with an alternative embodiment of the present invention;

FIG. 6 is a perspective view of yet another exemplary attachment clip designed to fit around a contoured section of a grease fitting in accordance with an alternative exemplary embodiment of the present invention;

FIG. 7 is a perspective view of yet another exemplary attachment clip configured to be secured to a bearing assembly by tightening a grease fitting;

FIG. 8 is a partial sectional perspective view of an end cover and attachment clip assembled in accordance with an exemplary embodiment of the present invention; and

FIG. 9 is a partial cross-sectional view of an end cover and bearing housing in accordance with an exemplary embodiment of the present invention.

### DETAILED DESCRIPTION

In accordance with exemplary embodiments disclosed herein, an injection moldable end cover assembly is provided. The arrangement may be adapted to fit a range of bearing housing styles, including standard pillow blocks, tapped base pillow blocks, two-bolt flanges, four-bolt flanges, flange brackets, piloted flanges, wide-slot take-up bearings, and top angle take-up bearings. As will be discussed in greater detail below, the end cover assembly may also fit bearing housings having a variety of sizes and dimensions without external machining of the bearing housing. The end cover assembly functions as a robust guard and cannot be easily dislodged by incidental contact.

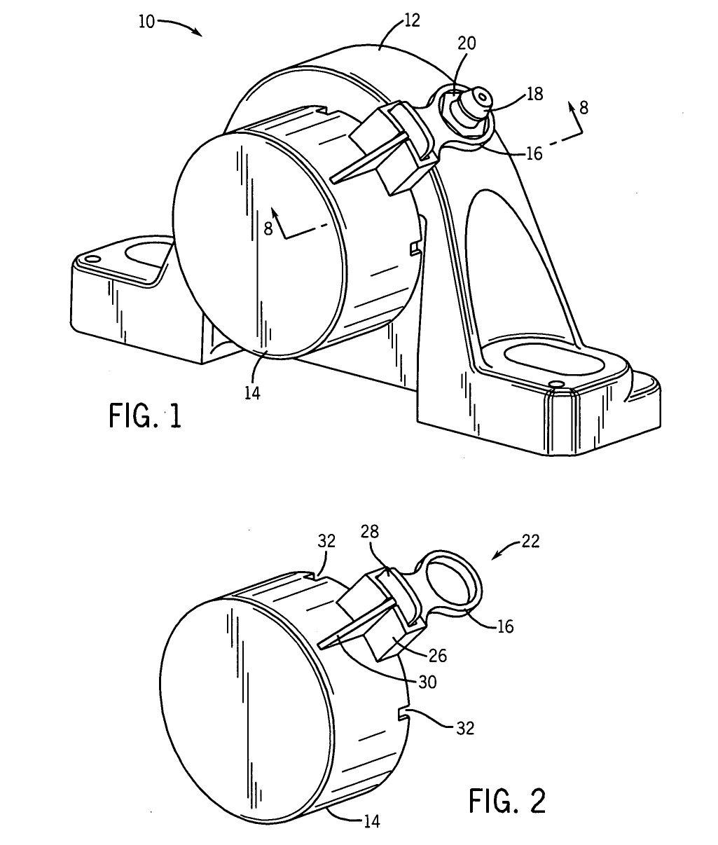

Turning initially to FIG. 1, a housing assembly is illustrated in accordance with an exemplary embodiment of the present invention and is generally referred to by the reference numeral 10. The housing assembly includes a bearing housing 12. The bearing housing 12 may be configured to house a variety of sizes of bearing assemblies and shafts. The bearing housing 12 may take a variety of forms, such as the pillow block housing illustrated in FIG. 1. Alternatively, the bearing housing 12 may be a tapped base pillow block, two-bolt flanges, four-bolt flanges, flange brackets, piloted flanges, wide-slot take-up bearings, or top angled take-up bearings. In general, the housing will mechanically receive and support a bearing set or insert (not shown) within a central aperture thereof. The shaft or other rotating member (not shown) supported by the bearing assembly will be inserted into the bearing set, in a manner generally known in the art.

The housing assembly 10 also includes an end cover 14 and an attachment clip 16. The end cover 14 may be inserted into a straight bore of the bearing housing 12, as described below. The attachment clip 16 is provided to secure the end cover 14 to the bearing housing 12. Specifically, the attachment clip 16 may be attached to the end cover 14 and secured to a grease fitting 18 of the bearing housing 12, or to any other fastener or structure on the housing with which the clip may interface and be mechanically supported.

Turning to FIG. 2, an end cover assembly is illustrated in accordance with an exemplary embodiment of the present invention and generally designated by the reference numeral 22. The end cover assembly 22 includes an end cover 14 and an attachment clip 16, as shown.

The end cover 14 and the attachment clip 16 are separate parts capable of forming a single rigid structure. Specifically, the attachment clip 16 can be coupled with the end cover 14 as shown in FIG. 2. The height of the attachment clip 16 relative to the end cover 14 can be adjusted incrementally as teeth formed on both the end cover 14 and the attachment clip 16 engage. Thus, the position of the attachment clip 16 relative to the end cover 14 can be adjusted to fit housings having a variety of thicknesses.

In particular, in the illustrated embodiment, the end cover 14 has a toothed tab 28 protruding from the outer surface of the end cover 14. A reinforcement rib 30 is provided for the toothed tab 28 and as its name indicates, provides reinforcement for the toothed tab 28. The reinforcement rib 30 protrudes from the outer surface of the end cover 14 in a generally perpendicular orientation to the toothed tab 28. Additionally, in the illustrated embodiment, the end cover 14 has slots 32 every 90 degrees around the open end of the end cover 14. The slots 32 are provided to allow condensation to exit the end cover 14 when placed in operation.

The attachment clip 16 has alignment tabs 26 for securing the attachment clip to the end cover 14. When the attachment clip 16 and the end cover 14 are coupled together, the alignment tabs 26 surround the toothed tab 28 protruding from the end cover 14. Compressive forces applied by the alignment tabs 26 hold the attachment clip 16 in position relative to the end cover 14, and ultimately, when placed in service, hold the end cover in a desired position with respect to a point of attachment of the attachment clip to the bearing housing.

As mentioned above, the end cover assembly 22, including the end cover 14 and the attachment clip 16, may be manufactured through an injection molding process. Specifically, the end cover 14 and the attachment clip 16 may be made of any suitable material, such as engineering plastics. In a presently contemplated embodiment, these components are made of acetal resin. For example, the acetal resin may be one commercially available under the designation Delrin®, sold by DuPont Company, of Wilmington, Del. The injection molding process provides for an efficient means for producing the end cover 14 and the attachment clip 16, and provides both economic and structural advantages over other methods. Such other methods may, however, be employed for forming parts falling within the scope of the invention.

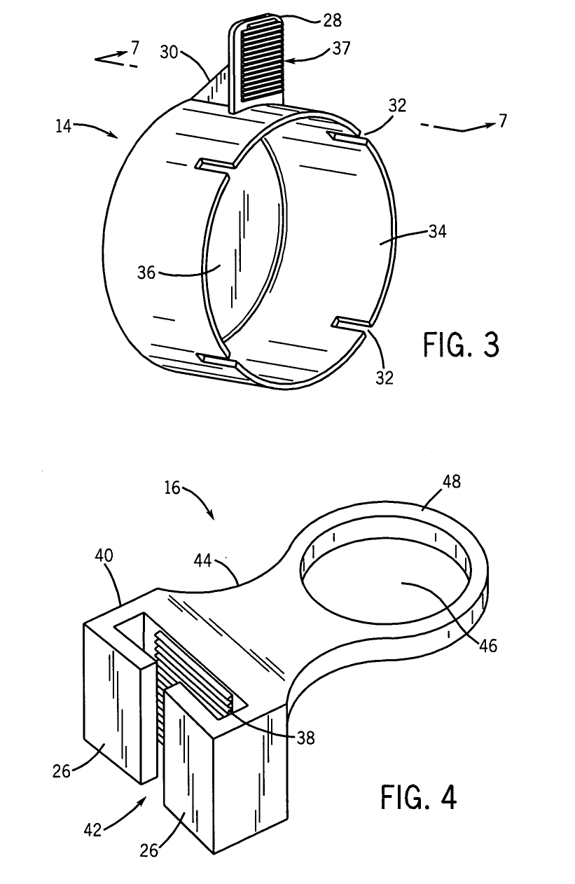

Another view of the end cover 14 is illustrated in FIG. 3 in accordance with an exemplary embodiment of the present invention. As can be seen, the end cover has a sidewall 34 having a generally conical shape and a back panel 36. As described previously, the sidewall 34 has slots 30 located around its periphery to allow condensation to exit the end cover 14 and the bearing housing 12. The reinforcement rib 30 and the toothed tab 28 are also shown.

The toothed tab 28 is designed to engage an attachment clip 16, as mentioned above. Specifically, the toothed tab 28 has teeth 37 for engaging a surface of an attachment clip 16. Although various methods may be used to create the teeth 37, one process is generally referred to as a pull. The pull process can achieve characteristics of 0.015 inches or less. The pull process may create a bias, meaning that the teeth may have angled profiles relative to the toothed tab 28.

When attaching the end cover to a bearing housing 12, the open end of the end cover 14 may be inserted into a straight bore of the bearing housing. Such bores may be provided in many bearing housings, and consist of a geometry of the housing at which the central opening has a straight cylindrical shape. This location may be ideal for receiving and stabilizing the end cover. The diameter of the end cover can vary according to the diameter of the straight bore of the bearing housing being used. Additionally, the straight bore may have an interference fit (not shown) so that the end cover fits securely in the straight bore. Once the end cover is coupled to the bearing housing, the sidewall 34 and the back panel 36 preclude exposure to a shaft that rotates during operation.

Turning to FIG. 4, the attachment clip 16 is illustrated in accordance with an exemplary embodiment of the present invention. The attachment clip 16 has alignment tabs 26, as described above, for securing the attachment clip 16 to an end cover 14. Additionally, the attachment clip 16 has a toothed wall 38 configured to engage the teeth 37 of the toothed tab 28 of FIG. 3. A tab slot 40 is provided between the alignment tabs 26 and the toothed wall 38. As the toothed tab 28 of the end cover 14 is inserted into the tab slot 40 of the attachment clip 16, the teeth 37 of the toothed tab 28 and the teeth of the toothed wall 38 engage to secure the attachment clip 16 to the end cover 14. A gap 42 is positioned between the alignment tabs 26 to allow for the attachment clip 16 to slide past the reinforcement rib 30 of the end cover 14.

As described above, the teeth 37 of the toothed tab 28 may have a bias feature. Similarly, the teeth of the toothed wall 38 may have a bias. This bias may comprise an asymmetrical cross sectional geometry that results in a force for sliding the tab into the cover that is different from (e.g., less than) the force required to extract or slide the tab out of engagement with the cover. That is, the teeth 37 may be biased in an opposing direction relative to the bias of the toothed wall 38 when the attachment clip 16 and the end cover 14 are coupled together. Thus, the teeth may slide past each other in one direction and interlock to prevent movement in the opposite direction. Thus, the bias feature may help to prevent the end cover 14 and attachment clip 16 assembly from becoming separated from each other.

In addition to attaching to the end cover 14, the attachment clip 16 is configured to be secured to the bearing housing 12. Specifically, the attachment clip 16 may be attached to any suitable point on the bearing housing, such as to a grease fitting or other structure of the bearing housing 12. The attachment clip 16 has a securement tab 44 having a generally orthogonal orientation relative to the toothed wall 38 and the alignment tabs 26. The securement tab 44 may take several forms and secure to the bearing housing in different ways, as will be described below in conjunction with alternative embodiments.

The securement tab 44 of attachment clip 16 is configured to allow the attachment clip 16 to be pressed around a head of a grease fitting. Thus, the attachment clip 16 does not require the removal or loosening of a grease fitting in order for the attachment clip 16 to be secured to a bearing housing 12. Specifically, an aperture 46 is provided to fit over the head of the grease fitting. An interference fit between the inner diameter 48 of the aperture 46 and the head securely attach the attachment clip 16 to the bearing housing 12.

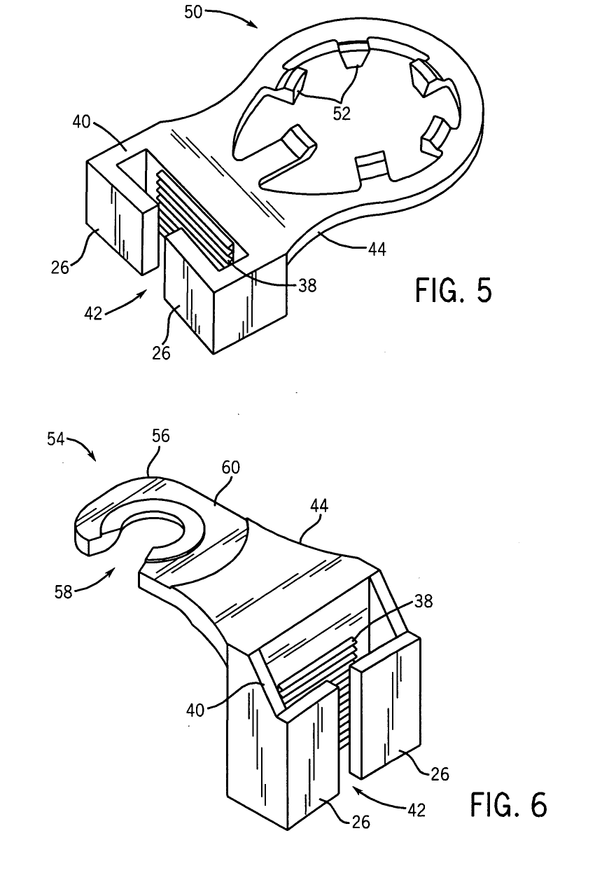

In accordance with an alternative exemplary embodiment, an attachment clip is illustrated in FIG. 5. Specifically, FIG. 5 illustrates an attachment clip 50 which can be pressed around a grease fitting of a bearing housing. The attachment clip 50 has similar features to the attachment clip 16 of FIG. 4. Alignment tabs 26 and a toothed wall 38 are provided to attach to an end cover 14. The securement tab 44, however, varies from the securement tab 44 of FIG. 3 in that snap tabs 52 are provided to allow for a secure fitting around a grease fitting or other structure of a bearing housing. The snap tabs 52 snap over the grease fitting or other structure and hold the attachment clip 50 in place.

In FIG. 6 an attachment clip that fits around the upper section of a grease fitting or other structure in accordance with an alternative exemplary embodiment of the present invention is illustrated and generally designated by the reference numeral 54. The attachment clip 54 is similar in many respects to the previously described attachment clips 16 and 50. Like the previously described attachment clips, there is no need to remove or loosen a grease fitting or any other part in order to attach the attachment clip 54 to a bearing housing.

The attachment clip 54 has a securement tab 44 with a section 56 configured to fit around a grease fitting of a bearing housing. Specifically, a fitting opening 58 is provided to allow the section 56 to secure to a grease fitting. Like the snap tabs 52 of the attachment clip 50, the section 56 secures the attachment clip 54 to the grease fitting. A recessed surface 60 may be provided on a top surface of the securement tab 44 to facilitate re-lubrication of a bearing housing.

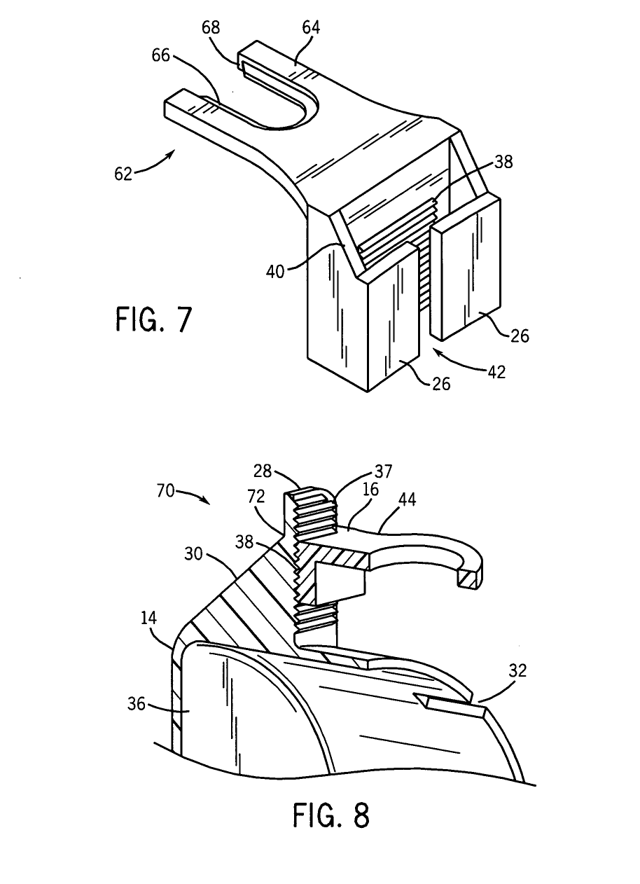

In FIG. 7 a perspective view of yet another alternative exemplary embodiment of an attachment clip is illustrated. The attachment clip 62 is configured to be secured to a bearing housing by tightening of the grease fitting. The attachment clip 62 has an open ended securement tab 64. The open ended securement tab 64 may have a metallic washer 66 positioned within the open ended securement tab 64. The metallic washer 66 may rest on a ledge 68 within the open ended securement tab 64. The metallic washer 66 may be configured to move axially within the open ended securement tab 64 so that the attachment clip 62 may be compatible with grease fitting that may have varying positions on a bearing housing.

The metallic washer 66 is illustrated as being a C-shaped washer so that the attachment clip 62 can be secured without entirely removing a grease fitting. The attachment clip 62 may simply attached by loosening the grease fitting and sliding the open ended securement tab 64 into place around the grease fitting. Once the securement tab 64 is in place the grease fitting may be tightened. Alternative embodiments (not shown) may have closed washers and the grease fitting may be removed in order to install a washer.

Turning to FIG. 8, a cross-sectional view of an end cover assembly 22 is illustrated in accordance with an exemplary embodiment of the present invention and is generally designated by the reference numeral 70. As can be seen in the cross-sectional view 70, the toothed tab 28 of the end cover 14 is coupled with the toothed wall 38 of the attachment clip 16. The teeth 37 of the end cover 14 and toothed wall 38 of the attachment clip 16 fix the position of the end cover 14 and the attachment clip 16 relative to each other to form a rigid structure. When the end cover 14 is inserted into the straight bore of a bearing housing, where available, and the attachment clip 16 is coupled to a structure of the bearing housing 12, the end cover assembly 22 cannot be easily dislodged through inadvertent or incidental contact.

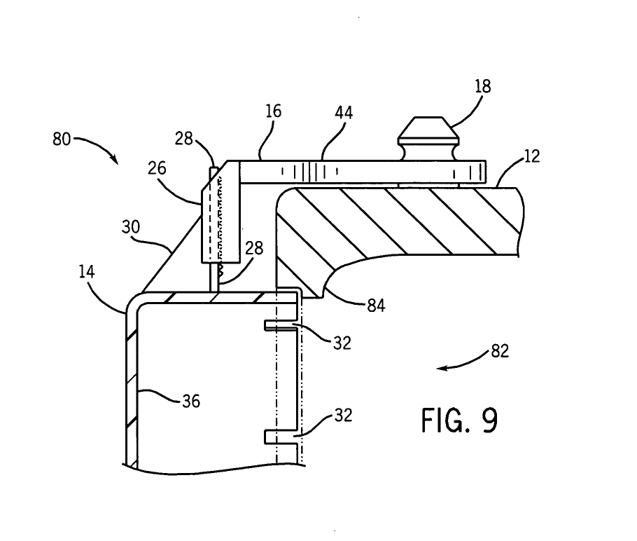

Turning to FIG. 9, a cross-sectional view of a bearing housing assembly 10 is illustrated in accordance with an exemplary embodiment of the present invention and is generally designated by the reference number 80. The cross-sectional view 80 shows the coupling of the end cover assembly 22 to the bearing housing 12. As can be seen in the cross-sectional view 80, the end cover 14 is inserted into the straight bore 82 of the bearing housing 12. The depth of insertion can vary according to particular parameters of specific bearing assembly. The end cover 14 is precluded from being inserted too far into the straight bore 82 by a short land 84.

Additionally, the attachment clip 16 is secured to the grease fitting 18. Various embodiments of the securement tab 44 have been described and provide different means for securing the attachment clip 16 to the bearing housing 12. The various embodiments may provide for varying heights of clearance between securement tab 44 and the bearing housing 12 to provide compatibility with various bearing housing sizes.

As discussed above, the end cover 14 and the attachment clip 16 provide a rigid structure when coupled together. The relative position of the end cover 14 and the attachment clip 16 can vary depending on the size of the bearing housing. As such, a single end cover and attachment clip 16 may be implemented for various sizes of bearing housings.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A bearing cover comprising:
a clip securable to a bearing housing; and
an end cover configured to cover a central opening of a bearing housing and to be secured to the clip.

2. The bearing cover of claim 1, wherein the clip and the end cover comprise an acetal resin.

3. The bearing cover of claim 2, wherein the clip and the end cover are formed by injection molding.

4. The bearing cover of claim 1, wherein the end cover is configured to fit into a straight bore of a bearing housing.

5. The bearing cover of claim 1, wherein the end cover has at least one drain slot formed in a periphery thereof.

6. The bearing cover of claim 1, wherein the clip comprises an aperture configured to fit over a head of a grease fitting secured to the bearing housing.

7. The bearing cover of claim 1, wherein the clip comprises snap tabs configured to fit over the grease fitting secured to the bearing housing.

8. The bearing cover of claim 1, wherein the clip comprises a head configured to interface with a grease fitting secured to the bearing housing.

9. The bearing cover of claim 8, wherein the head has a recessed surface configured to facilitate access to a grease fitting.

10. The bearing cover of claim 1, wherein the clip and end cover include a plurality of teeth engaging with one another to permit a relative position of the end cover and the clip to be varied for different sizes of bearing housing.

11. A bearing housing assembly comprising:
a bearing housing having an attachment structure;
a clip securable to the bearing housing attachment structure; and
an end cover securable to the clip to cover a central opening of the bearing housing.

12. The bearing housing assembly of claim 11, wherein the end cover fits into a straight bore of the bearing housing.

13. The bearing housing of claim 11, wherein the clip and the end cover form a rigid structure, and the position of the clip relative to the end cover can be adjusted.

14. The bearing housing of claim 11, wherein the attachment structure includes a grease fitting secured to the bearing housing.

15. The bearing housing of claim 14, wherein the clip is configured to be secured to a hexagonal head of the grease fitting.

16. The bearing housing of claim 11, wherein the clip and end cover include toothed surfaces configured to interface with one another to permit the clip and end cover to be secured to one another and to maintain a position of the cover with respect to the clip.

17. A method of covering a bearing assembly comprising:
disposing an end cover over a central opening of a bearing housing;
securing a clip to a structure of the bearing housing; and
coupling the clip to the end cover.

18. The method of claim 17 wherein securing the clip to a structure of the bearing housing comprises securing the clip to a head of a grease fitting mounted on the bearing housing.

19. The method of claim 17, wherein clip and the end cover are coupled by interfacing toothed teeth on both the clip and end cover to establish a desired position of the end cover over the central opening of the bearing housing.

20. The method of claim 17, comprising fitting the end cover within a straight bore of the bearing housing.
